(19) United States
(12) Patent Application Publication
(10) Pub. No.: US 2025/0021613 A1
(43) Pub. Date: Jan. 16, 2025

(54) QUANTUM CONSTRAINED HAMILTONIAN OPTIMIZATION

(71) Applicant: ColdQuanta, Inc., Boulder, CO (US)

(72) Inventors: Benjamin Prescott Hall, La Grange, IL (US); Michael A. Perlin, Chicago, IL (US)

(21) Appl. No.: 18/593,276

(22) Filed: Mar. 1, 2024

Related U.S. Application Data
(60) Provisional application No. 63/526,614, filed on Jul. 13, 2023.

(51) Int. Cl. G06F 17/11

(52) U.S. Cl. CPC G06F 17/11

(57) ABSTRACT

A device includes applying coupling and transformation operations to quantum states according to a Hamiltonian specification. Information is received at a digital computer based in part on measurements of the quantum states. The digital computer provides information for preparing quantum states associated with quantum processing elements based in part on the information. A control module applies coupling and transformation operations based on interaction with the digital computer for processing the constrained optimization problem. The processing includes preparing quantum states associated with quantum processing elements characterized by a summation of a constraint Hamiltonian and an objective Hamiltonian. The processing further includes operating the control module to evolve a time-dependent Hamiltonian by forming a sum of a first term having the constraint Hamiltonian and a second term. The second term includes a product that is initially equal to the objective Hamiltonian and is evolved into a negative of the objective Hamiltonian.

### CROSS REFERENCE TO OTHER APPLICATIONS

This application claims priority to U.S. Provisional Application No. 63/526,614, entitled Quantum Constrained Hamiltonian Optimization, filed Jul. 13, 2023, which is incorporated herein by reference for all purposes.

### BACKGROUND OF THE INVENTION

Constrained combinatorial optimization problems represent a class of computational challenges where the goal is to find the optimal solution from a finite set of feasible solutions, subject to a set of constraints. These problems are characterized by discrete decision variables and a multitude of constraints that limit the feasible solution space. The objective is to maximize or minimize an objective function while adhering to the specified constraints. Common examples include the traveling salesman problem, job scheduling, and network design. The complexity of these problems arises from the discrete nature of the decision variables, leading to a combinatorial explosion of possible solutions and requiring sophisticated algorithms for efficient exploration of the solution space.

Addressing constrained combinatorial optimization problems involves the development and application of various optimization techniques. Metaheuristic algorithms, such as genetic algorithms, simulated annealing, and ant colony optimization, are commonly employed due to their ability to navigate large solution spaces and find near-optimal solutions. These algorithms iteratively explore and exploit the solution space, balancing the trade-off between exploration for diverse solutions and exploitation to refine the current best-known solution. Additionally, mathematical programming techniques, such as integer programming and constraint programming, offer formal frameworks for modeling and solving constrained combinatorial optimization problems. These methods provide a systematic approach to formulate the problem, express constraints, and leverage optimization solvers to find optimal or near-optimal solutions.

Despite the advancements in optimization algorithms, constrained combinatorial optimization problems remain challenging due to their NP-hard nature. Efficiently solving large instances of these problems requires a combination of algorithmic innovations, problem-specific heuristics, and computational resources. The complexity and ubiquity of constrained optimization problems motivates the development of quantum algorithms as a new approach to tackle them.

### BRIEF DESCRIPTION OF THE DRAWINGS

For a more complete understanding of the invention, reference is made to the following description and accompanying drawings, in which:

FIG. 1 is a diagram of an example hybrid quantum-classical computing system in accordance with respective examples.

FIG. 2 illustrates summary data of MIS simulation results in accordance with respective examples.

FIG. 3 illustrates summary data of DMDS simulation results with random directed graphs in accordance with respective examples.

FIG. 4 illustrates summary data of knapsack simulation results in accordance with respective examples.

FIG. 5 illustrates histograms results for a specific example of the knapsack problem in accordance with respective examples.

FIG. 6 illustrates summary data of combinatorial auction simulation results in accordance with respective examples.

FIG. 7 illustrates histograms of combinatorial simulation results for a specific example of a combinatorial auction in accordance with respective examples.

FIG. 8 is a flowchart for processing a constrained optimization problem in accordance with respective examples.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more examples of the invention is provided below along with accompanying figures that illustrate various features of the invention. The invention is described in connection with such examples, but the invention is not limited to any example. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Described herein is an adiabatic quantum algorithm, quantum constrained Hamiltonian optimization (Q-CHOP), that may be used for solving constrained optimization problems. In various implementations, Q-CHOP enforces a Hamiltonian constraint at all times, and constructs an adiabatic path directly out of the problem's objective function to convert the worst feasible state into the best feasible state. In contrast to the standard approaches to adiabatic quantum optimization, Q-CHOP constructs the entire adiabatic schedule out of optimization problem data, without invoking an ad-hoc driver Hamiltonian or initial state that have no relation to the problem at hand. Q-CHOP further comes equipped with a natural choice for the constraint-enforcing “penalty factor”, leaving only the quantum runtime as a hyperparameter that may need careful tuning for performance. Q-CHOP consistently outperforms the standard, penalty-based adiabatic algorithm in numerical experiments across a diverse set of problems, suggesting that Q-CHOP is a promising general-purpose method for constrained combinatorial optimization.

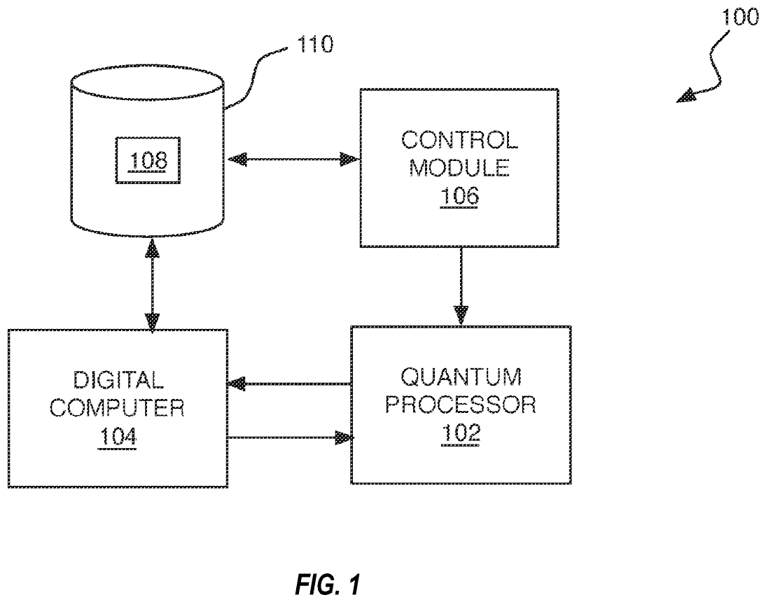

Referring to FIG. 1, an example hybrid quantum-classical computing system 100 includes a quantum processor 102 comprising a plurality of quantum processing elements associated with respective quantum states. In some examples, the quantum processor 102 may be a physical quantum processor. In other examples, the quantum processor 102 may be a simulation of a physical quantum processor. The quantum processor 102 is configured to apply coupling operations (e.g., multi-qubit operations) and transformation operations (e.g., single-qubit operations) to a plurality of the quantum states according to a quantum circuit specification (e.g., QC specification 108 stored on a storage medium 110) defining a plurality of quantum gate operations. A digital computer 104 comprises at least one central processing unit, and is configured to: receive information based at least in part on measurements of one or more quantum states associated with respective quantum processing elements of the quantum processor 102, and provide information for preparing one or more quantum states associated with respective quantum processing elements of the quantum processor 102 based at least in part on the received information. A control module 106 is configured to control the applied coupling and transformation operations (e.g., using radio frequency electromagnetic fields coupled to a coupled array of superconducting circuits, or using optical electromagnetic fields coupled to atoms) based on interaction with the digital computer 104 for processing a constrained optimization problem. The processing comprises: preparing quantum states associated with a plurality of the quantum processing elements characterized by a first Hamiltonian representing a constraint of the constrained optimization problem, preparing quantum states associated with a plurality of the quantum processing elements characterized by a second Hamiltonian representing an objective function of the constrained optimization problem, and operating the control module to evolve a time-dependent Hamiltonian according to an evolution that includes: (1) forming an expression that is initially equal to a product of the first Hamiltonian and at least one time-dependent function that includes the second Hamiltonian as an argument of an exponential function, or (2) forming a sum of a first term comprising the first Hamiltonian and a second term, where the second term comprises a product of (A) a time-dependent scalar function and (B) a time-dependent operator that is initially equal to the second Hamiltonian and is evolved into the negative of the second Hamiltonian.

In some implementations, the quantum computing algorithm represented by the quantum circuit specification is used for evolving the time-dependent Hamiltonian over a first iteration comprising a sequence of discrete time intervals. These discrete time intervals can be variationally optimized using a processor (e.g., a classical processor such as the processor core(s) of the digital computer 104, or a quantum processor, or a hybrid quantum-classical computing system that includes both a classical processor and a quantum processor). For example, after evolving the time-dependent Hamiltonian over the first iteration, a variational optimization of the second Hamiltonian may be performed to determine a second iteration comprising a second sequence of discrete time intervals. The variational optimization may include performing gradient descent, Adam, etc. The same sequence of discrete time intervals may be evolved repeatedly in order to generate an expectation value of the second Hamiltonian for a given sequence of discrete time intervals. In such a case, the variational optimization would optimize the expectation value of the second Hamiltonian.

As way of background, consider a constrained combinatorial optimization problem of the form:

$$minimize : f ( x ) \qquad ( 1 )$$

$$subject to : {C}_{i} ( x ) = 0 for all i .$$

$$x ∈ {\{ 0 , 1 \}}^{N} minimize : f ( x )$$

$$subject to : {C}_{i} ( x ) = 0 for all i .$$

$$x ∈ {\{ 0 , 1 \}}^{N}$$

Here f is the objective function and Cᵢ are constraints. It is assume without loss of generality that the all constraint functions are nonnegative, which implies that they are minimized by constraint-satisfying (feasible) bitstrings; otherwise, Cᵢ(x) can be replaced in Eq. (1) by \tilde{C}ᵢ(x)=Cᵢ(x)². The treatment of inequality constraints is discussed further below.

Under the assumption of nonnegative constraints, the optimization problem in Eq. (1) can be encoded into a system of qubits by the objective and constraint Hamiltonians:

$${H}_{obj} = {\sum }_{x} f ( x ) \vert x 〉 〈 x \vert , {H}_{con} = {\sum }_{i , x} {C}_{i} ( x ) \vert x 〉 〈 x \vert , \qquad ( 2 )$$

thereby associating “good” bitstrings of low objective-function value with low-energy states of H_{obj}, and identifying the set of feasible bitstrings with the ground-state subspace of H_{con}. Thusly encoded, the optimization problem in Eq. (1) can be solved via the adiabatic algorithm.

To this end, the standard procedure is to first construct a problem Hamiltonian H_{prob}=H_{obj}+λH_{con} with a penalty factor for constraint violation, A, that is sufficiently large to ensure that the ground state of H_{prob} is feasible. One then chooses a driver Hamiltonian H_{driver} that satisfies two properties: (i) it has an easy-to-prepare ground state, and (ii) it does not commute with H_{prob}. Finally, the quantum algorithm prepares the ground state of H_{driver}, and slowly changes the Hamiltonian of the system from H_{driver} to H_{prob} over the course of a total time T, for example via the interpolating Hamiltonian:

$${H}_{interp} ( s ) = ( 1 - s ) {H}_{driver} + {sH}_{prob} , \qquad ( 3 )$$

sweeping s: 0→1 as the time t: 0→T.

T is referred to as the “quantum runtime” of the algorithm. Property (i) is necessary to ensure that the algorithm solves the optimization problem by adiabatically tracking the ground state of Hᵢₙₜₑᵣₚ, while property (ii) ensures that Hᵢₙₜₑᵣₚ has off-diagonal terms that induce nontrivial dynamics.

Choosing an interpolating Hamiltonian of the form in Eq. (3) is not required, and indeed sometimes different paths from H_{driver} to H_{prob} can improve performance, in the extreme case turning algorithmic failure into success. For simplicity, however, the interpolating Hamiltonian is considered. This approach is referred to as the standard adiabatic algorithm (SAA).

The adiabatic theorem ensures that the SAA prepares an optimal solution in time T that scales with an inverse power of the smallest spectral gap Δᵢₙₜₑᵣₚ^{min} of Hᵢₙₜₑᵣₚ(minimized over s∈[0, 1]), provided that there are no symmetries that fragment Hilbert space into uncoupled sectors. However, the gap Δᵢₙₜₑᵣₚ^{min} is usually not known in advance, so in practice the SAA requires making an ad hoc choice of some “long” time T, and hoping that T is sufficiently large. If the selected time is too small, the SAA will not only fail to provide an optimal solution, it may even fail to provide a feasible solution.

There are a few additional shortcomings of the SAA that are worth noting. First, the SAA requires making a careful choice of the penalty factor λ. Increasing λ makes it more likely that the SAA finds feasible solutions to the optimization problem at hand. However, doing so also increases the runtime of the algorithm, or equivalently the depth of a quantum circuit that implements this algorithm with fixed error. Making an optimal choice of λ has been shown to be a difficult task in practice and NP-hard in general, though known heuristic strategies exist that work well in certain cases.

Second, the SAA relies on an ad hoc initial state and driver Hamiltonian H_{driver} that has no connection to the problem of interest. A common choice for the initial state is the uniform superposition over all bitstrings (representing the uniform prior), and a transverse magnetic field for which the uniform superposition is a unique ground state. However, even here one must choose an overall normalization (prefactor) for H_{driver}, analogous to the choice of penalty factor λ. Finally, there is an intuitive sense in which the SAA does “too much work”: it searches the configuration space of all bitstrings, feasible or otherwise.

Described below are various examples of quantum constrained Hamiltonian optimization (Q-CHOP) and its application to problems with various objectives and constraints. The Pauli-Z operator for qubit j∈{1, 2, . . . , N} is denoted by Zⱼ=|0 [symbol] 0|ⱼ−|1 [symbol] 1|ⱼ, the Pauli-X operator by Xⱼ=|0 [symbol] 1|ⱼ+|1 [symbol] 0|ⱼ, and the Pauli-Y operator by Yⱼ=−iZⱼXⱼ. The generator of a global rotation about axis α∈{x, y, z} on the Bloch sphere is denoted by S_{α}, e.g.

$${S}_{z} = \frac{1}{2} {\sum }_{j} {Z}_{j} ,$$

such that R_{α}(θ)=e^{-iθS}^{_{α}} rotates all qubits about axis α by the angle θ.

The general strategy for Q-CHOP is as follows:
1. Identify an initial Hamiltonian Hᵢₙᵢₜ whose energy within the space [symbol] _{feas} of feasible states is minimized by an easy-to-prepare state |xᵢₙᵢₜ [symbol] ∈ [symbol] _{feas}. Prepare |xᵢₙᵢₜ [symbol] .
2. Construct a ramp Hᵣₐₘₚ(s) that traces a continuous path from Hᵢₙᵢₜ to the objective Hamiltonian H_{obj}, with Hᵣₐₘₚ(0)=Hᵢₙᵢₜ and Hᵣₐₘₚ(1)=H_{obj}.
3. Pick a time T and a positive real number A, and evolve from time t=0 to t=T under the total Hamiltonian

$${H}_{tot} ( s ) = {H}_{con} + {λ}^{- 1} {H}_{ramp} ( s ) , \qquad ( 4 )$$

with s: 0→1 as t: 0→T.
   In various examples below, explicit choices of Hᵢₙᵢₜ and Hᵣₐₘₚ that are constructed out of the objective Hamiltonian H_{obj} are provided. However, general features of the strategy in steps 1-3 are discussed first.

Intuitively the constraint Hamiltonian H_{con} will restrict dynamics to the feasible subspace [symbol] _{feas}, while the ramp Hᵣₐₘₚ will adiabatically transfer the initial state |xᵢₙᵢₜ [symbol] to an optimal (or approximate) solution to the optimization problem. In this general form, Q-CHOP shares many features with the SAA. The scalar A is analogous to the penalty factor in the SAA, and indeed the Hamiltonians of Q-CHOP and the SAA at s=1 are equal (up to an overall normalization factor). Similarly, the choices of an initial Hamiltonian Hᵢₙᵢₜ and a ramp Hᵣₐₘₚ for Q-CHOP are analogous to choices of a driver Hamiltonian H_{driver} and a path from H_{driver} to H_{prob} in the SAA.

Though this general form of Q-CHOP does not practically reduce the number of choices necessary to solve the constrained optimization problem, it effectively reduces the size of the classical search space of the quantum algorithm, which can reduce requisite runtimes. Moreover, Q-CHOP provides a theoretical framework for making a suitable choice of λ. Denote the operator norm of M by ∥M∥, let ∥Hᵣₐₘₚ∥=max_{s∈[0,1]} ∥Hᵣₐₘₚ(s)∥, and denote the spectral gap of H_{con} by Δ_{con}. If

$$‖ {H}_{ramp} ‖ / λ < {Δ}_{con} / 2 , and \qquad ( a )$$

$${H}_{ramp} changes slowly with respect to {Δ}_{con}^{- 1} , \qquad ( b )$$

then second-order perturbation theory guarantees that Q-CHOP will yield feasible states with probability

$${p}_{feas} = 1 - O ( {δ}^{2} ) , where δ = \frac{‖ {H}_{ramp} ‖}{{λΔ}_{con}} . \qquad ( 5 )$$

Intuitively, condition (a) ensures that the Hᵣₐₘₚ is not “strong enough” to violate constraints, while condition (b) precludes rapid (e.g., Floquet) driving schemes that resonantly pump energy into the system. The spectral gap Δ_{con} can typically be determined (or at least lower-bounded) by inspection of the constraint Hamiltonian H_{con}.

Larger values of penalty factor λ provide better guarantees of feasible solutions, while smaller values of λ are desirable to increase the weight of the ramp Hᵣₐₘₚ that drives evolution within the feasible subspace. Condition (a) and the guarantee in Eq. (5) provide an upper bound on “reasonable” choices of λ, namely λₘₐₓ≈2∥Hᵣₐₘₚ∥/Δ_{con}. In practice, even the upper bound λ≤λₘₐₓ is too stringent, as the above discussion still holds if the norm ∥Hᵣₐₘₚ(s)∥ is replaced by ∥(1−P_{feas})Hᵣₐₘₚ(S)P_{feas}∥, where P_{feas} is a projector onto the feasible subspace. One should therefore expect smaller values of λ to still yield predominantly feasible states, although the limits on λ may need to be found empirically, since the norm ∥(1−P_{feas})HᵣₐₘₚP_{feas}∥ is generally not known a priori. Moreover, the ramp that constructed and described below has the feature that ∥Hᵣₐₘₚ∥≤∥H_{obj}∥. The fact that a suitable choice of λ can be determined from ∥H_{obj}∥ and Δ_{con} directly, rather than from a significantly more complex interpolating Hamiltonian in the case of the SAA, is a notable advantage of Q-CHOP, since these quantities are typically easy to estimate or bound appropriately. A uniform linear objective

$${H}_{obj} = {S}_{z} = \frac{1}{2} {\sum }_{j} {Z}_{j} ≃ - {\sum }_{j} {\vert 1 〉 〈 1 \vert}_{j}$$

(where ≃ denotes equality up to a constant), for example, has norm ∥H_{obj}∥=N/2, so if Δ_{con}=1 then λ=N is a reasonable choice. However, in the worst case, determining the optimal choice of λ may be NP-hard as is the case for the SAA.

It is often the case that the objective function of an optimization problem is linear in the decision variables of the problem, in which case the corresponding objective Hamiltonian can be written (up to an irrelevant constant shift) as a weighted sum of single-qubit Pauli-Z operators. This Hamiltonian is then odd with respect to qubit inversion, which is to say that [symbol] x|H_{obj}|x [symbol] =− [symbol] x̅|H_{obj}|x̅ [symbol] , where x=(x₁, x₂, . . . )∈{0, 1}^{N} is a bitstring and x̅=(1−x₁, 1−x₂, . . . ) is its bitwise complement. It is also sometimes the case that finding good solutions to a constrained optimization problem is difficult, but finding the worst feasible solution is easy, either by inspection or with an efficient classical algorithm. This is the case for the problem of finding a maximum independent set (MIS), whose worst feasible state is the all-0 bitstring. When the objective is odd, the asymmetry between best and worst feasible states motivates the choice of initial Hamiltonian Hᵢₙᵢₜ=−H_{obj}, and a ramp that continuously flips all qubits: Hᵣₐₘₚ(θ)=−H_{obj}(θ), with

$${H}_{obj} ( θ ) = {R}_{y} ( θ ) {H}_{obj} {R}_{y} {( θ )}^{†} \qquad ( 6 )$$

where parameterising the ramp is by the angle θ=sπ for brevity, and R_{y}(θ)=e^{-iθS}^{_{y}} rotates all qubits about the y axis by θ.

When these two conditions hold, namely objective Hamiltonian is odd worst feasible state |x_{worst} [symbol] is easy-to-prepare, the Q-CHOP can be done as follows. Prepare |x_{worst} [symbol] , pick a quantum runtime T and positive number λ≈2∥H_{obj}∥/Δ_{con}, and evolve from time t=0 to t=T under the total Hamiltonian

$${H}_{tot} ( θ ) = {H}_{con} - {λ}^{- 1} {H}_{obj} ( θ ) , \qquad ( 7 )$$

sweeping θ: 0→π as t: 0→T, for example with the linear ramp θ=πt/T. Here ∥H_{obj}∥ is the operator norm of H_{obj}, and Δ_{con} can be replaced by an estimate or lower bound on the spectral gap of H_{con}. The prescription for choosing λ is only a guideline, and smaller values of λ may work well in practice. λ was set equal to the qubit number N in all examples described herein.

In the case of MIS, Q-CHOP may reduce to the specialized algorithm based on non-Abelian adiabatic mixing, up to an adiabatically vanishing addition of ∂ₜθS_{y} to Hₜₒₜ(θ) in Eq. (7). However, the general formalism of Q-CHOP extends to more general constrained optimization problems as well. Intriguingly, the addition of ∂ₜθS_{y} can be identified with approximate counterdiabatic driving, and its form depends only on the linearity of the MIS objective function. An added term of ∂ₜθS_{y} is therefore expected to marginally improve the performance of Q-CHOP for any optimization problem with linear objectives, and similar approximate counterdiabatic driving terms can likely be derived for non-linear objectives as well.

In various examples, Q-CHOP may be sped up for problems with single-body objective Hamiltonians of the form:

$${H}_{obj} = \frac{1}{2} {\sum }_{j} {c}_{j} {Z}_{j} , \qquad ( 8 )$$

where {cⱼ} are arbitrary real coefficients. For convenience and clarity, H_{obj,z}=H_{obj}, as well as rotated versions H_{obj,x} and H_{obj,y} in which the Pauli-Z operators in H_{obj,z} are respectively replaced by Pauli-X and Pauli-Y operators. The restriction of Hamiltonians to the feasible subspace is denoted as [symbol] _{feas} by a superscript, such that H_{obj,α}^{feas}=P_{feas}H_{obj,α}P_{feas}, where P_{feas} is a projector onto [symbol] _{feas}.

Q-CHOP may rely on the adiabatic theorem to track the ground state of a Hamiltonian H(θ) by slowly varying a parameter θ. Evolving too quickly introduces errors due non-adiabatic effects. These effects can be mitigated by the introduction of a counterdiabatic drive, in which the Hamiltonian is replaced according to

$$H \to {H}_{CD} = H + {\partial }_{t} θ G , \qquad ( 9 )$$

where the gauge field G can be found by minimizing the Hibert-Schmidt norm of the operator

$$𝒪 ( G , H ) = {\partial }_{θ} H + i [ G , H ] . \qquad ( 10 )$$

Here [G, H]=GH−HG, and the (squared) Hilbert-Schmidt norm of [symbol] is ∥ [symbol] ∥_{HS}²=tr( [symbol] ).

When time evolution is sufficiently slow to avoid exciting states outside the feasible subspace, Q-CHOP effectively evolves from time t=0 to t=T under the Hamiltonian

$${H}_{tot}^{feas} ( θ ) = - {λ}^{- 1} {H}_{obj}^{feas} ( θ ) , \qquad ( 11 )$$

$$with$$

$${H}_{obj}^{feas} ( θ ) = {P}_{feas} {R}_{y} ( θ ) {H}_{obj} {{R}_{y} ( θ )}^{†} {P}_{feas} , \qquad ( 12 )$$

where the angle θ: 0→π as t: 0→T. As Hₜₒₜ^{feas}(θ) is the Hamiltonian to augment with a counterdiabatic drive, next is to find a gauge field G that minimizes the norm of [symbol] (G, Hₜₒₜ^{feas}) which is equivalent to minimizing the norm of [symbol] (G, H_{obj}^{feas}). To this end, the following expansion may be used:

$${H}_{obj}^{feas} ( θ ) = cos ( θ ) {H}_{obj , z}^{feas} + sin ( θ ) {H}_{obj , x}^{feas} \qquad ( 13 )$$

and in turn

$${\partial }_{θ} {H}_{obj}^{feas} ( θ ) = - sin ( θ ) {H}_{obj , z}^{feas} + cos ( θ ) {H}_{obj , x}^{feas} . \qquad ( 14 )$$

It is unclear how to minimize the norm of [symbol] (G, H_{obj}^{feas}) exactly, so minimizing it variationally with respect to the ansatz may be used:

$${G}_{g} = {g}_{x} {S}_{x}^{feas} + {g}_{y} {S}_{y}^{feas} + {g}_{z} {S}_{z}^{feas} , \qquad ( 15 )$$

$$where$$

$${S}_{α}^{feas} = {P}_{feas} {S}_{α} {P}_{feas} , \qquad ( 16 )$$

for which

$$𝒪 ( {G}_{g} , {H}_{obj}^{feas} ) = {\partial }_{θ} {H}_{obj}^{feas} ( θ ) + i cos ( θ ) [ {G}_{g} , {H}_{obj , z}^{feas} ] + i sin ( θ ) [ {G}_{g} , {H}_{obj , x}^{feas} ] . \qquad ( 17 )$$

Nonzero values of gₓ and g_{z} only contribute to imaginary components to [symbol] (G_{g}, H_{obj}^{feas}), and conversely all imaginary components of [symbol] (G_{g}, H_{obj}^{feas}) involve factors of gₓ or g_{z}. To minimize the Hilbert-Schmidt norm of [symbol] (G_{g}, H_{obj}^{feas}), set gₓ=g_{z}=0 and define G_{y}=g_{y}S_{y}^{feas}, leaving:

$$𝒪 ( {G}_{y} , {H}_{obj}^{feas} ) = {\partial }_{θ} {H}_{obj}^{feas} ( θ ) + {ig}_{y} cos ( θ ) [ {S}_{y}^{feas} , {H}_{obj , z}^{feas} ] + {ig}_{y} sin ( θ ) [ {S}_{y}^{feas} , {H}_{obj , x}^{feas} ] . \qquad ( 18 )$$

The projector P_{feas} commutes with H_{obj,z} (both are diagonal in the computational basis), which allows a simplification:

$$[ {S}_{y}^{feas} , {H}_{obj , z}^{feas} ] = {P}_{feas} [ {S}_{y} , {H}_{obj , z} ] {P}_{feas} = {iH}_{obj , x}^{feas} . \qquad ( 19 )$$

Further substituting ∂_{θ}H_{obj}^{feas}(θ) from Eq. (14) into Eq. (18), provides:

$$𝒪 ( {G}_{y} , {H}_{obj}^{feas} ) = cos ( θ ) ( 1 - {g}_{y} ) {H}_{obj , x}^{feas} - sin ( θ ) ( {H}_{obj , z}^{feas} - {ig}_{y} [ {S}_{y}^{feas} , {H}_{obj , x}^{feas} ] ) . \qquad ( 20 )$$

The sin(θ) term vanishes as θ→0 or π, at which point [symbol] (g_{y}S_{y}^{feas}, H_{obj}^{feas}) is minimized by g_{y}=1. Near θ=π/2, the sin(θ) term dominates, but here no definite statements about the norm of [symbol] (G_{y}, H_{obj}^{feas}) can be made without knowledge of the feasible subspace. Nonetheless, given that i [S_{y}, H_{obj,x}]=H_{obj,z}, i [S_{y}^{feas}, H_{obj,x}^{feas}] is generally expected to be “H_{obj,z}^{feas}-like” so a minimum near g_{y}˜1 is expected. In some examples, the gauge field G=S_{y} is a reasonable (albeit sub-optimal) choice to mitigate non-adiabatic effects. In the case of linear objectives, the total Hamiltonian for Q-CHOP with approximate counterdiabatic driving thus becomes

$${H}_{tot} \to {H}_{tot , CD} = {H}_{con} - {λ}^{- 1} {H}_{obj} ( θ ) + {\partial }_{t} θ {S}_{y} . \qquad ( 21 )$$

The small factor of ∂ₜθ˜1/T prevents ∂ₜθ S_{y} from generating a population transfer to non-feasible states, so ∂ₜθ S_{y}≈∂ₜθ S_{f}^{feas}.

In some examples, the requirement of an odd objective used in Sec. ?? is relaxed and a modification of the algorithm that no longer requires the worst feasible state to be easy-to-prepare. In the case of a non-odd objective, the prescription in Eq. (6) needs modification to ensure that the rotated objective Hamiltonian changes sign when θ: 0→π. To this end, the objective can be decomposed into Pauli strings as

$${H}_{obj} = \frac{1}{2} {\sum }_{S ⊂ {ℤ}_{N}} {c}_{S} {\prod }_{j ∈ S} {Z}_{j} , \qquad ( 22 )$$

where [symbol] _{N}={1, 2, . . . , N} is the set of qubit indices. Next one qubit in each term is rotated, and average over each choice of qubits, altogether defining

$${H}_{obj} ( θ ) = \frac{1}{2} {\sum }_{S ⊂ {ℤ}_{N}} \frac{{c}_{S}}{\vert S \vert} {\sum }_{j ∈ S} {R}_{y} ( θ ) {Z}_{j} {{R}_{y} ( θ )}^{†} {\prod }_{k ∈ S \backslash \{ j \}} {Z}_{k} , \qquad ( 23 )$$

$$where$$

$${R}_{y} ( θ ) {Z}_{j} {{R}_{y} ( θ )}^{†} = cos ( θ ) {Z}_{j} + sin ( θ ) {X}_{j} . \qquad ( 24 )$$

In some examples, the objective is decomposed into even and odd terms, rotate the odd terms globally as in Eq. (6), and rotate the even terms “locally” as in Eq. (23). These examples may have the benefit of reduced computational overheads when discretizing Q-CHOP for gate-based quantum computation. In some examples, the terms of a Hamiltonian may be made up of a sum of components.

In some examples of Q-CHOP, the worst feasible state of a constrained optimization problem is easy to prepare is required. In other examples, however, this requirement is relaxed to that of having at least one feasible state that is easy to prepare. For example, let |x_{★} [symbol] be an easy-to-prepare eigenstate of H_{obj}, and let E_{★}= [symbol] x_{★}|H_{obj}|x_{★} [symbol] be the corresponding objective energy. Define a subproblem with the same constraint Hamiltonian as the original optimization problem, H_{con}, but a new objective Hamiltonian

$${H}_{obj}^{★} = - {( {H}_{obj} - {E}_{★} )}^{2} , \qquad ( 25 )$$

for which |x_{★} [symbol] is the worst feasible state. By construction, H_{obj}^{★} is minimized within the feasible subspace by either the best feasible state |x_{best} [symbol] or worst feasible state |x_{worst} [symbol] of the original optimization problem, depending on which corresponding objective energy (with respect to H_{obj}) is farther from E_{★}. If the optimization subproblem defined by (H_{obj}^{★}, H_{con}) is solved by |x_{best} [symbol] , then after solving the subproblem the process is complete. Otherwise, the worst feasible state |x_{worst} [symbol] identified by the subproblem to solve the original optimization problem (H_{obj}, H_{con}) can be used. The relaxation of Q-CHOP from needing the worst feasible state to needing any feasible state comes at the cost of having to solve a subproblem with an objective H_{obj}^{★} that has quadratically larger norm, and can therefore be expected to require a larger penalty factor λ^{★} and a larger quantum runtime T*. There may additionally be concerns if the energy E_{★} has degeneracy d_{★}>>1, in which case a population transfer into the ground state of the final Q-CHOP Hamiltonian can be expected to be suppressed by a factor of 1/d_{★}.

Next, the treatment of inequality constraints in Q-CHOP and the SAA is discussed. An inequality constraint of the form D(x)≥0 can be converted into an equality constraint by the introduction of a slack variable: D(x)=n, where n≥0 is a new decision variable for the optimization problem. This equality constraint can then be rearranged and squared to arrive at the constraint

$${C}_{D} ( x , n ) = {( D ( x ) - n )}^{2} = 0 , \qquad ( 26 )$$

at the cost of expanding the optimization domain as {0,1}^{N}→{0, 1}^{N}×{0, 1, 2, . . . }. The Hamiltonian enforcing this constraint takes the form

$${{H}_{con}^{D} = ( {\sum }_{x} D ( x ) \vert x 〉 〈 x \vert - {\hat{n}}_{D} )}^{2} , \qquad ( 27 )$$

where \hat{n}_{D}=Σ_{n≥0} n|n [symbol] n|_{D} is a number operator that can be identified with an auxiliary bosonic mode indexed by the constraint function D. In this sense, bosonic modes may be resources for enforcing inequality constraints.

In practice, the dimension of a slack variable can be truncated at Dₘₐₓ=maxₓ D(x) to encode a problem into a finite-dimensional Hilbert space. A discrete-variable encoding of the slack variable then requires └log₂(Dₘₐₓ+1)┐ qubits, though it may be desirable to encode the slack variable directly into a qudit or oscillator. If the maximum of D is not efficiently computable, Dₘₐₓ can be replaced by an upper bound on D(x). Expanding

$$D ( x ) = {\sum }_{S ⊂ {ℤ}_{N}} {c}_{S}^{D} {\prod }_{j ∈ S} {x}_{j} , \qquad ( 28 )$$

where each xⱼ∈{0, 1}, denotes the constant contribution to D(x) by c₀^{D}=c_{{ }}^{D}, and the set of remaining coefficients by C_{D}={c_{S}^{D}: S⊂ [symbol] _{N}, |S|>0}. A suitable upper bound for D(x) is then given by the sum of positive coefficients in C_{D},

$${\tilde{D}}_{max} = sum ( {𝒞}_{D} ⋂ {ℤ}_{+} ) + {c}_{0}^{D} , \qquad ( 29 )$$

where [symbol] _{±} denotes the set of positive (+) or negative (−) integers. If the coefficients in C_{D} have a nontrivial greatest common divisor gcd(C_{D})>1, the dimensionality of the slack variable can be further reduced by pruning its allowed values to the set

$${𝕊}_{D} = ( gcd ( {𝒞}_{D} ) ℤ + {c}_{0}^{D} ) ⋂ [ 0 , {\tilde{D}}_{max} ] . \qquad ( 30 )$$

For the SAA, the introduction of a slack variable may force a choice of initial state and driver Hamiltonian for the corresponding slack qudit. A natural generalization of the qubit-only case is to interpret the initial state |+ [symbol] ^{⊗N} and transverse-field driver Hamiltonian

$${{H}_{driver} = - \frac{1}{2} {\sum }_{j} {X}_{j} ≃ - {\sum }_{j} \vert + 〉 〈 + \vert}_{j}$$

respectively as a uniform prior and a sum of projectors onto the uniform prior for each decision variable. Here ≃ denotes equality up to an overall constant. This interpretation motivates initializing the slack qudit into a uniform superposition of its domain, and adding the (negative) projector onto this state to the driver Hamiltonian. In some examples, this generalization of initial state and driver Hamiltonian is used.

In some examples of Q-CHOP, there are two subtleties to address for the treatment of inequality constraints. First, once an initial worst feasible state |x_{worst} [symbol] is identified, the slack variable for inequality constraint D may be initialized to |n_{worst} [symbol] =|D(x_{worst}) [symbol] . Second, merely adding a slack qudit with the constraint in Eq. (27) to the Q-CHOP Hamiltonian fragments Hilbert space into uncoupled sectors indexed by the value of n=D(x). Initializing the slack variable in |n_{worst} [symbol] thereby enforces, in effect, the much stronger constraint that D(x)=n_{worst}. To remedy this situation, a strategy of engineering an alternative adiabatic path that adds thoughtfully chosen mixing terms to the Q-CHOP Hamiltonian may be used.

In order to satisfy the constraint enforced by Eq. (27), added mixing terms may be used to couple the decision variables and the slack variables, changing them in a correlated manner. A Hamiltonian term that flips qubit j, for example, should simultaneously change the value of all slack variables associated with inequality constraints that involve variable xⱼ, so as to ensure that inequality constraints remain satisfied. However, engineering a strictly constraint-satisfying mixing Hamiltonian would involve complex multi-control logic that may generally be inefficient to implement. Accordingly, in some examples, slack variables are allowed to change to any value, and rely on the always-on constraint Hamiltonian of Q-CHOP to make constraint-violating terms off-resonant. For problems with inequality constraints, the objective Hamiltonian of Q-CHOP may be modified using a slack variable mixing operator S(θ). As a specific example of S(θ), the objective Hamiltonian of Q-CHOP may be modified as H_{obj}(θ)→H_{obj}(θ)×S(θ), with

$$𝒮 ( θ ) = 1 + sin ( θ ) {\prod }_{D} \vert {𝕊}_{D} \vert {P}_{+}^{D} . \qquad ( 31 )$$

Here | [symbol] _{D}| is the dimension of the slack qudit for constraint D and P₊^{D} is a projector onto is uniform superposition |+ [symbol] _{D}=Σ_{n∈} [symbol] _{_{D}}|n [symbol] /\sqrt{| [symbol] _{D}|}, such that | [symbol] _{D}|P₊^{D}= [symbol] |m [symbol] n|_{D}. The factor of sin θ ensures that the added mixing terms vanish at θ=0 and π, which is necessary to preserve the initial and final ground states of the Q-CHOP Hamiltonian.

If the polynomial D(x) has degree d and coefficients with magnitude O(1), then | [symbol] _{D}|=O(N^{d}). It is therefore worth noting that the slack operator in Eq. (31) grows with the product of the slack variable dimensions, Π_{D}| [symbol] _{D}|. Though it is not surprising for the cost of solving an optimization problem to grow with the degree of its inequality constraints, it is highly desirable to have a cost that does not grow multiplicatively with the number of inequality constraints.

### Numerical Experiments and Analysis

Described below are specific examples that compare the performance of Q-CHOP numerically using exact simulation and to SAA. A comprehensive performance comparison between Q-CHOP and the SAA requires a detailed, problem-aware assessment of the numerous choices that are made to instantiate simulation Hamiltonians, including choices of normalization factors, driver Hamiltonians (for the SAA), penalty factor, adiabatic schedules, and total evolution times.

To simulate Q-CHOP, an initial state is evolved with the Hamiltonian in Eq. (7) using a linear ramp, θ=πt/T. In the case of the SAA, the initial state |+ [symbol] ^{⊗N}∝(|0 [symbol] +|1 [symbol] )^{⊗N} is evolved with the Hamiltonian

$${H}_{SAA} ( t ) = - ( 1 - \frac{t}{T} ) {S}_{x} + \frac{t}{T} ( {H}_{con} + {λ}^{- 1} {H}_{obj} ) , \qquad ( 32 )$$

where

$${{S}_{x} = \frac{1}{2} {\sum }_{j} {X}_{j} ≃ {\sum }_{j} \vert + 〉 〈 + \vert}_{j}$$

is a transverse field normalized to have a spectral range equal to the qubit number N and the penalty factor is λ=N. For optimization problems with slack qudits, the qudits are initialized to a uniform superposition and projectors are added onto these initial states to Sₓ. In all the described experiments, the objective Hamiltonian is normalized to make the optimization problems scale-invariant. Specifically, H_{obj} is set to H_{obj}/ [symbol] (H_{obj}), where the normalization factor [symbol] (H_{obj}) defined in terms of the nonzero coefficients of H_{obj} in Eq. (22) by

$${𝒩 ( {H}_{obj} )}^{2} = {𝔼}_{{{c}_{S} \neq 0}_{S \neq \{ \}}} {c}_{S}^{2} . \qquad ( 33 )$$

Here [symbol] denotes an average, and the empty set is excluded to make the norm [symbol] (H_{obj}) independent of constant shifts to H_{obj}. This normalization is equivalent to that of up to a constant factor of four. The constant factor is chosen so that [symbol] (S_{z})=1 for the uniform linear objective S_{z}≃−Σⱼ|1 [symbol] 1|ⱼ with spectral range N.

Unlike the objective Hamiltonians, constraint Hamiltonians typically have a natural expression as a sum of projectors, each of which has a spectral range of 1. This ensures that the constraint Hamiltonians have a spectral gap of at least 1, and typically equal (or otherwise close) to 1. Therefore, no additional preconditioning of the constraint Hamiltonians are performed unless specified otherwise. For problems with inequality constraints, all constraint coefficients are divided by their greatest common divisor by taking D(x)→D(x)/gcd(C_{D}∪c₀^{D}), prune the set of allowed slack variable values, and modify the SAA and Q-CHOP Hamiltonians to address slack variables as discussed above.

To highlight the features and results and various implementations, the following metrics are used to measure the performance of an optimization algorithm. The first is the in-constraint approximation ratio r, which is defined so that the best and worst feasible states have values of 1 and 0, respectively. The operator whose expectation is equal to the in-constraint approximation ration is given by

$$r = {P}_{feas} ( \frac{{H}_{obj} - {E}_{worst}}{{E}_{best} - {E}_{worst}} ) {P}_{feas} , \qquad ( 34 )$$

where P_{feas} is a projector onto the feasible-state manifold, and [symbol] = [symbol] |H_{obj}| [symbol] for [symbol] ∈{best, worst} are the objective energies of the best and worst feasible states.

TABLE 0.1
Problems simulated below and features
that are relevant for Q-CHOP.

| | odd | no inequality |
|---|---|---|
| problem | objective | constraints |
| MIS | yes | yes |
| DMDS | yes | yes |
| knapsack | yes | no |
| comb. auction | yes | no |

The second quantity is the overlap between the state produced by the quantum algorithm and the state encoding the optimal solution to the optimization problem. The corresponding operator is the projector onto the optimal solutions of an optimization problem:

$${P}_{opt} = {\sum }_{x : 〈 x \vert r \vert x 〉 = 1} \vert x 〉 〈 x \vert . \qquad ( 35 )$$

For optimization problems whose objective function values may lie anywhere on the real line, finding the exact solution is too strict of a criterion for success. In this case, the overlap with E-optimal states may be used, with the operator given by

$${P}_{ϵ} = {\sum }_{x : 〈 x \vert r \vert x 〉 \geq 1 - ϵ} \vert x 〉 〈 x \vert . \qquad ( 36 )$$

Table 0.1 summarizes the problems that are simulate in the numerical experiments described below, and some features that are relevant for Q-CHOP. All simulations were performed by numerically integrating equations of motion using the DOP853 method of scipy.integrate.solve_ivp, with both absolute and relative error tolerances set to 10⁻⁸.

### Maximum Independent Set

The problem of finding a maximum independent set (MIS) is considered first. Given a graph G=(V, E), a set S⊂V is an independent set if none of its vertices are neighbors; that is, {v, w}∉E for all v, w∈S. A maximum independent set is an independent set containing the largest possible number of vertices. Candidate solutions S⊂V to MIS can be identified by bitstrings x={xᵥ: v∈V}∈{0, 1}^{|V|} for which xᵥ=1 if and only if v∈S. The identification of subsets is referred to as the membership encoding into |V|-bit strings. MIS can thus be defined by the following integer program:

$$maximize : {\sum }_{v ∈ V} {x}_{v} \qquad ( 37 )$$

$$subject to : {x}_{v} {x}_{w} = 0 for all \{ v , w \} ∈ E ,$$

$$x ∈ {\{ 0 , 1 \}}^{\vert V \vert} .$$

The constraints of MIS are sometimes equivalently written as xᵥ+x_{w}≤1, but the formulation with equality constraints in Eq. (37) avoids the need for slack variables. The worst feasible solution to MIS is the empty set, identified by the all-0 bitstring x=(0, 0, . . . ). Many constrained optimization problems, including as maximum clique, minimum vertex cover, and maximum set packing, are straightforwardly reducible to MIS with no significant overhead.

Solving MIS with an adiabatic quantum algorithm was previously considered by Yu, Wilczek, and Wu. Specifically, solving MIS with Q-CHOP is equivalent to running the Yu, Wilzcek, and Wu algorithm with λ=−4 and T=4N². However, the previously known algorithm provides little insight into the choice λ. As a specific example, previous work did not discuss the fact that making |∂ₜφ| too large (|λ| too small) makes the algorithm for MIS fail due to population leakage outside of the feasible subspace. In contrast, the formalism of Q-CHOP makes clear from Eq. (5) that one should choose |λ|˜N. The Q-CHOP formalism additionally clarifies that choosing ∂ₜφ>0 (λ<0) makes these algorithms track the state of maximal energy within the feasible subspace, making them more vulnerable to mixing with non-feasible states.

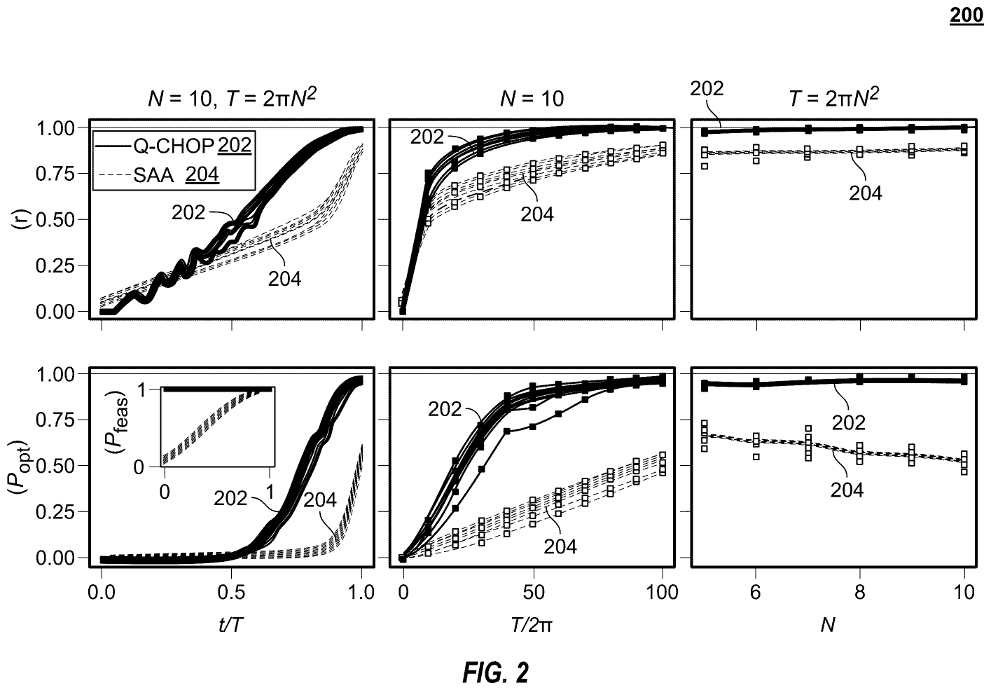

FIG. 2 illustrates the summary of MIS simulation results 200. Expectation values of (top row) the approximation ratio r and (bottom row) the optimal-state projector Pₒₚₜ in simulations of MIS with Q-CHOP 202 and the SAA 204. (Left-most panels) time-series data in simulations of 10 random graphs with N=10 vertices and quantum runtime T=2πN². The inset shows the in-constraint probability P_{feas} over time for the same simulations. (Middle panels) values at the end of simulations with the same random graphs, but different quantum runtimes T. (Right-most panels) values at the end of simulations with different qubit numbers (vertices). Lines in the right-most panels track average values for each qubit number N.

To evaluate Q-CHOP on MIS and to compare its performance to that of SAA, random (Erdös-Rényi) graphs G(N, p) with N vertices and edge-creation probability p=0.3 were considered. FIG. 2 summarizes simulation results from solving MIS with Q-CHOP and the SAA on random graphs for different qubit numbers N and quantum runtimes T. The primary takeaway from these results is that Q-CHOP not only outperforms the SAA in finding high-quality solutions on average (measured by the approximation ratio r), but also finds the optimal solution with significantly higher probability (measured by the projector Pₒₚₜ). The probability of finding an optimal solution also grows much faster with respect to the quantum runtime T when solving MIS with Q-CHOP as opposed to the SAA. Moreover, for Q-CHOP the probability of finding an optimal solution remains roughly constant with respect to N when T˜N², whereas for the SAA this probability decays with N. For the SAA, a linear regression test rejects the null hypothesis of constant [symbol] Pₒₚₜ [symbol] with respect to N (at T=2πN²) with a p-value of 6×10⁻⁴ (in favor of a negative slope), whereas for Q-CHOP, the null hypothesis is rejected with p-value of 0.01 in favor of a positive slope. While the utility of a linear regression test is limited for a quantity that is bounded on [0, 1], it illustrates the statistical significance of the trend observed in FIG. 2.

### Directed Minimum Dominating Set

Another example is the problem of finding a directed minimum dominating set (DMDS). Given a directed graph G=(V, E), a vertex v∈V is dominated by a vertex u∈V if the directed edge (u, v)∈E. A dominating set of G is then a subset S⊂V for which every vertex of the graph is either contained in S, or dominated by a member of S. A minimum dominating set of a graph is a dominating set containing the fewest possible vertices. DMDS can be defined by the following integer program:

$$minimize : {\sum }_{v ∈ V} {x}_{v} \qquad ( 38 )$$

$$subject to : {\overline{x}}_{v} {\prod }_{( u , v ) ∈ E} {\overline{x}}_{u} = 0 for all v ∈ V ,$$

$$x ∈ {\{ 0 , 1 \}}^{\vert V \vert} ,$$

where the binary variable x denotes membership in the dominating set and x̅ᵥ=1−xᵥ for shorthand. The constraint for vertex v ensures that either v∈S (in which case x̅ᵥ=0), or one of its neighbors u: (u, v)∈E is in S (in which case x̅ᵤ=0). The worst feasible solution to DMDS is the all-inclusive set S=V, identified by the all-1 bitstring x=(1, 1, . . . ). The integer program formulation of DMDS in Eq. (38) superficially resembles that of MIS in Eq. (37), and indeed the problem of finding a minimum dominating set on an undirected graph can be reduced to solving MIS on a hypergraph. The definition of DMDS on a directed graph, however, prevents its straightforward reduction to a variant of MIS.

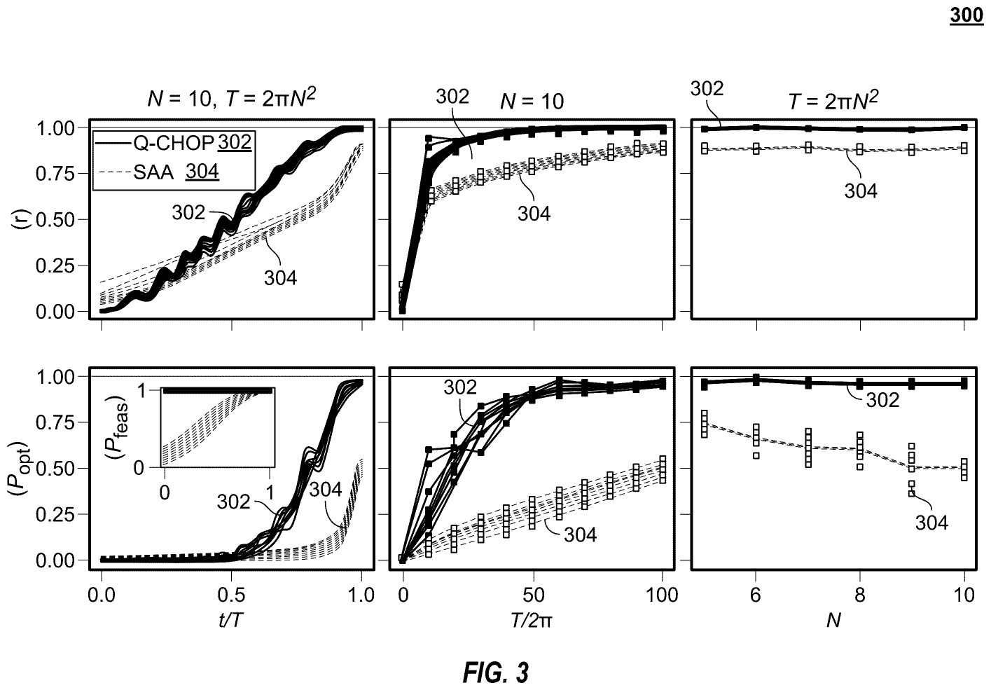

FIG. 3 illustrates a summary of DMDS simulation results with random directed graphs, presented in a format identical to FIG. 2. FIG. 3 provides a summary of using Q-CHOP 302 and the SAA 304 to solve DMDS on directed Erdös-Rényi graphs with edge-creation probability p=0.3, and existing edges are assigned a random orientation 300. Altogether, the results and conclusions from FIG. 3 are strikingly similar to those for MIS, likely due to the similarity of the underlying ensemble of graphs that define the MIS and DMDS problem instances. As with MIS, Q-CHOP yields high-quality solutions to DMDS on average, and has a higher probability of finding an optimal solution. The optimal state probability for Q-CHOP again grows faster with quantum runtime T, and does not decay with problem size N (Q-CHOP data in the is consistent with the null hypothesis of no decay, while for the SAA the null hypothesis is rejected with p-value 5×10⁻⁴), suggesting a potential advantage in scaling.

### Knapsack

Q-CHOP is useful for problems beyond graph problems. For example, Q-CHOP may be used on the knapsack problem, a widely studied combinatorial optimization problem with applications in logistics and finance. The difficulty of solving the knapsack problem is the basis of knapsack cryptosystems, which are candidates for post-quantum cryptography, and closely-related lattice-based cryptosystems are under active consideration for the development of post-quantum cryptographic standards. A knapsack problem consists of a collection of items I to be placed in a “knapsack”. Each item i∈I has a weight wᵢ and value vᵢ, and the knapsack has weight capacity W. The goal is to choose a subset of items that maximizes value without exceeding the capacity of the knapsack. Again identifying subsets of I with the membership encoding, the knapsack problem can be defined by the following integer program:

$$minimize : {\sum }_{i ∈ I} {v}_{i} {x}_{i} \qquad ( 39 )$$

$$subject to : {\sum }_{i ∈ I} {w}_{i} {x}_{i} \leq W ,$$

$$x ∈ {\{ 0 , 1 \}}^{\vert I \vert} .$$

The knapsack problem thereby introduces inequality constraints for Q-CHOP and the SAA, so simulating a knapsack problem instance requires a total Hilbert space dimension of 2^{|I|}(W+1). The worst feasible state of knapsack problem is the all-0 state.

The task of generating classically hard knapsack problem instances was previously studied by Jooken, Leyman, and De Causmaecker, with an implementation of their instance generator provided at: https://github.com/JorikJooken/knapsackProblemlnstances.

In addition to a number of items N and knapsack capacity W, an ensemble of random instances generated by the above method is defined by a number of groups g that determine item weight and value statistics, a fraction of items f that are assigned to the last group, an upper bound s on the value and weight of items in the last group, and a noise parameter ∈. As an experiment, to produce random knapsack problem instances with N items, the above generator implementation with (W, g, f, s, E)=(2N, ┌N/2┐, 1/N, N, 0.1) can be used. Any knapsack problem instances in which any item has weight greater than W are rejected.

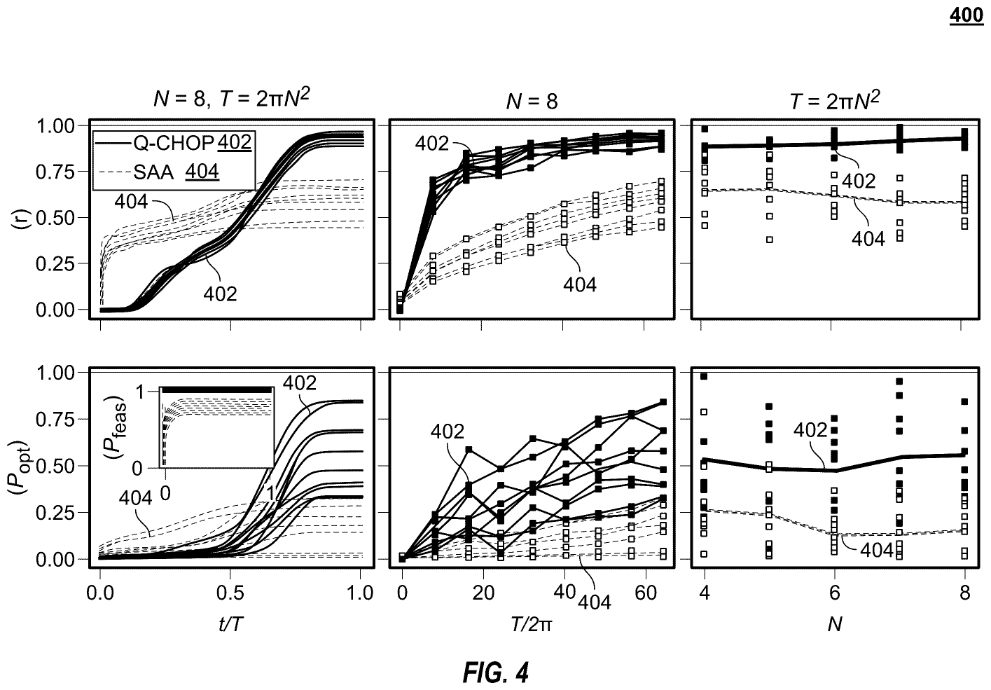

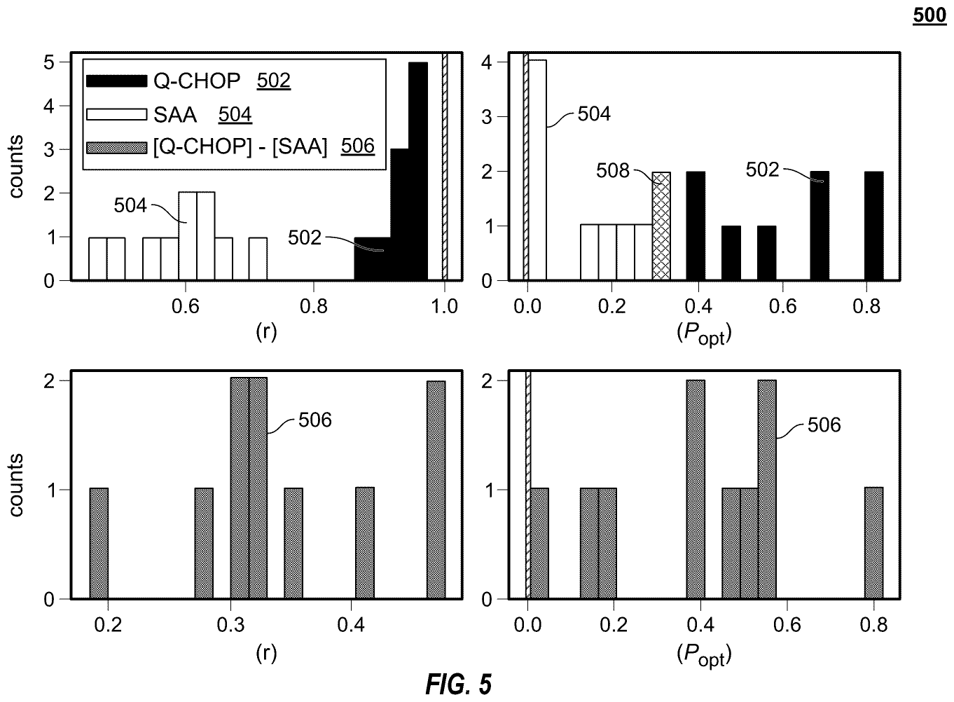

FIG. 4 illustrates a summary of knapsack simulation results 400, presented in a format identical to FIG. 1. N as shown in FIG. 4 is the number of items in a knapsack instance. FIG. 5 illustrates histograms results for a specific example of the knapsack problem 500. In FIG. 5, the (Top panels) histograms are of final approximation ratios [symbol] r [symbol] and optimal state probabilities [symbol] Pₒₚₜ [symbol] from knapsack simulations with N=8 items and quantum runtime T=2πN². The data in the top panels here is a coarse-grained slice of the data at time t=T in the left-most panels of FIG. 4. Darker bars 508 indicate that Q-CHOP 502 and SAA 504 values lie within the same histogram bin. In the (Bottom panels), the histograms of the performance differences (as measured by [symbol] r [symbol] and [symbol] Pₒₚₜ [symbol] ) between Q-CHOP and the SAA 506 in the same simulations as the top panels are shown. Q-CHOP outperforms the SAA in every simulated knapsack problem instance with N=8 items.

FIG. 4 shows the results of knapsack problem simulations with Q-CHOP 402 and the SAA 404, and additional data about results at N=8 and T=2πN² is provided in FIG. 5. The performance of Q-CHOP and the SAA for the knapsack problem is more variable than that for MIS and DMDS, which can be attributed to a richer ensemble of problem instances. The SAA generally fails to produce final states that lie within the feasible-state manifold, and in some cases essentially fails to find an optimal state altogether. Interestingly both Q-CHOP and the SAA exhibit plateau behavior in the growth of [symbol] r [symbol] and [symbol] Pₒₚₜ [symbol] with progress t/T throughout the solution of individual problem instances. Even so, Q-CHOP achieves reliably high approximation ratios, and finds optimal states with higher probability than the SAA in every simulated instance (see FIG. 5). Q-CHOP also achieves significantly higher approximation ratios and optimal-state probabilities with shorter quantum runtimes T than the SAA, though there is high variability in the growth of [symbol] Pₒₚₜ [symbol] with T. The performance gap between Q-CHOP and the SAA persists for different problem sizes N.

### Combinatorial Auction

As another example, the problem of optimizing a combinatorial auction (CA), which is commonly used mechanism for market-based resource allocation and procurement, is considered. A combinatorial auction consists of a collection I of items to be sold, and a set B of bids that offer to purchase baskets of items. Each item i∈I has multiplicity mᵢ. Each bid b=(P_{b}, q_{b})∈B offers to pay p_{b} for the basket of items specified by the vector q_{b}=(q_{bi}: i∈I), where q_{bi} is the quantity of item i in the basket requested by bid b. The goal of a combinatorial auction is for the seller to accept a subset of the bids that maximizes payments without exceeding the available inventory of items. Identifying the subset of accepted bids by the membership encoding, a combinatorial can be defined by the following integer program:

$$maximize : {\sum }_{b ∈ B} {p}_{b} {x}_{b} \qquad ( 40 )$$

$$subject to : {\sum }_{b ∈ B} {q}_{bi} {x}_{b} \leq {m}_{i} for all i ∈ I ,$$

$$x ∈ {\{ 0 , 1 \}}^{\vert B \vert} .$$

Due to the inequality constraints and associated slack variables, a simulating a combinatorial auction problem instance requires a total Hilbert space dimension of 2^{|I|}Π_{i∈I}(mᵢ+1). The worst feasible solution of the combinatorial auction is the all-0 state.

As can be seen by comparing Eq. (39) to Eq. (40), the knapsack problem can be interpreted as a combinatorial auction consisting of one item with multiplicity W. A combinatorial auction of unique items (in which all multiplicities mᵢ=1) can be also be reduced to an instance of weighted MIS on a graph (V, E) in which nodes are identified with bids, V=B, and weighted by the payments p_{b} in the objective function, as in Eq. (40). The edges E are obtained by inserting, for each item i∈I, a complete graph on the bids that request item i. In other words, E=∪_{i∈I} Eᵢ with Eᵢ={{a, b}: qₐᵢ=q_{bi}=1}.

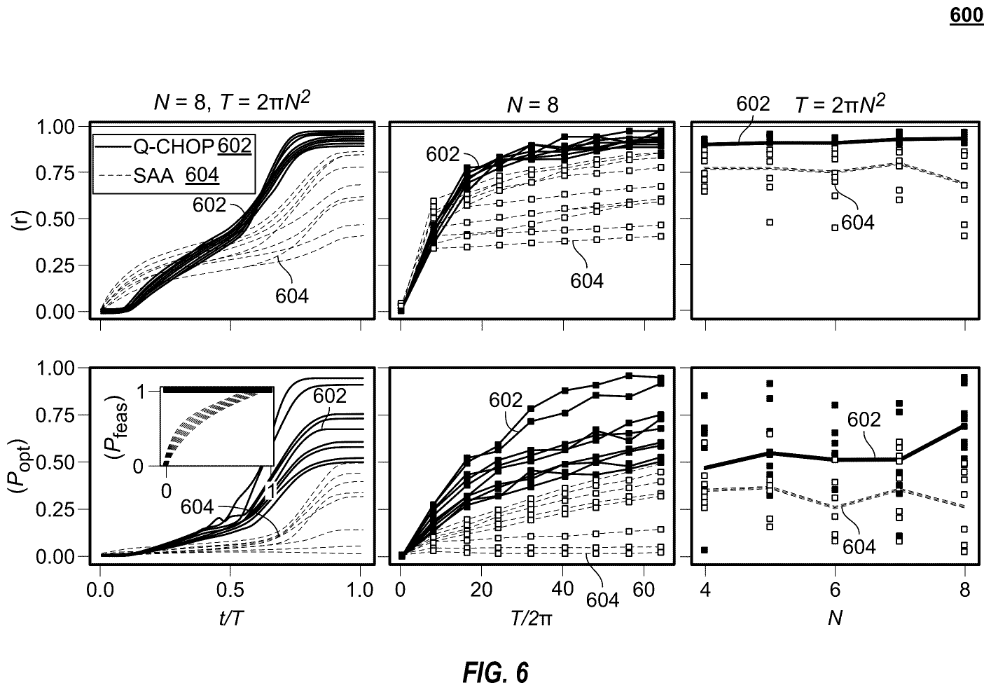

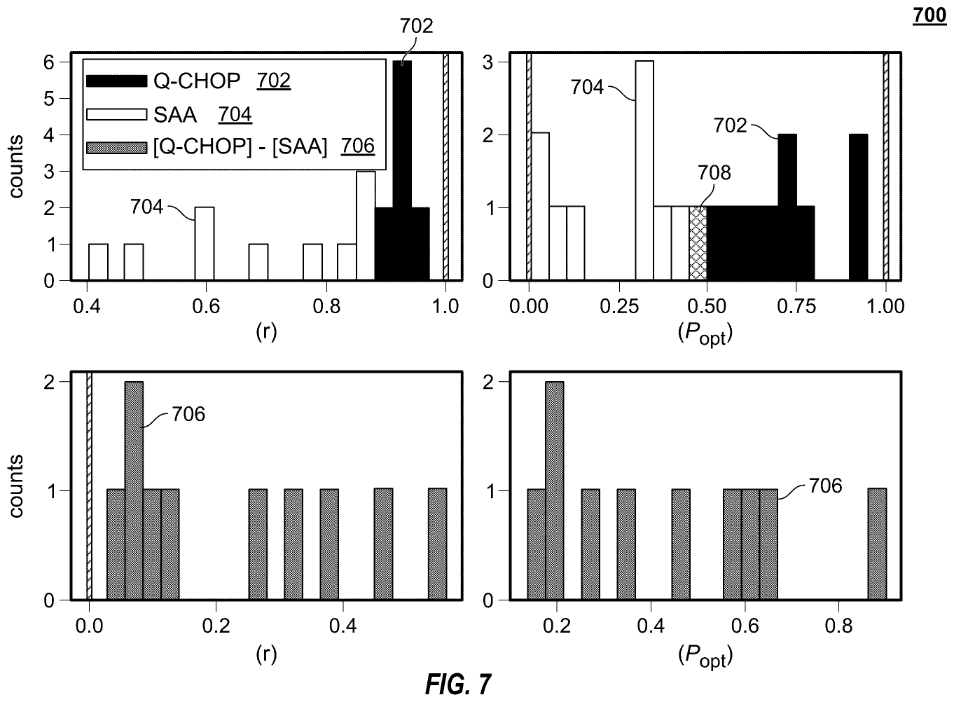

FIG. 6 illustrations a summary of combinatorial auction simulation results 600, presented in a format identical to FIG. 1. In FIG. 6, N is the number of bids in the combinatorial auction. FIG. 7 illustrates histograms of combinatorial simulation results for N=8 bids and quantum runtime T=2πN² 700, presented in a format identical to Figure FIG. 5. Darker bars 708 indicate that Q-CHOP 702 and SAA 704 values lie within the same histogram bin. In the (Bottom panels), the histograms of the performance differences (as measured by [symbol] r [symbol] and [symbol] Pₒₚₜ [symbol] ) between Q-CHOP and the SAA 706 in the same simulations as the top panels are shown. Q-CHOP outperforms the SAA in every simulated combinatorial auction problem instance with N=8 bids.

To generate combinatorial auction problem instances, the implementation of the Combinatorial Auction Test Suite provided by Gasse, Chelelat, Ferroni, Charlin, and Lodi was used. Instances of combinatorial auctions with |I|=3 items and N bids for varying N were generated. All other parameters defining an ensemble of combinatorial auctions are set to the defaults as in the provided implementation. These defaults set all multiplicities mᵢ=1, so the combinatorial auction instances are equivalent to instances of weighted MIS drawn from an appropriately defined ensemble of weighted graphs. For the sake of testing Q-CHOP and the SAA with inequality constraints, however, the formulation of the combinatorial auction in Eq. (40) were kept, which is simulated with auxiliary slack variables.

FIG. 6 and FIG. 7 summarize the combinatorial auction simulation results. Similarly to the results for the knapsack problem, both Q-CHOP 602, 702 and SAA 604, 704 performance is variable across different problem instances, though for the SAA the growth of [symbol] r [symbol] and [symbol] Pₒₚₜ [symbol] tapers off with progress t/T rather than hitting a plateau. Despite exhibiting plateau behavior, Q-CHOP still achieves more reliably high approximation ratios, higher optimal-state probabilities, and a faster growth of these performance metrics with quantum runtime T. The performance gap between Q-CHOP and the SAA persists for different problem sizes N.

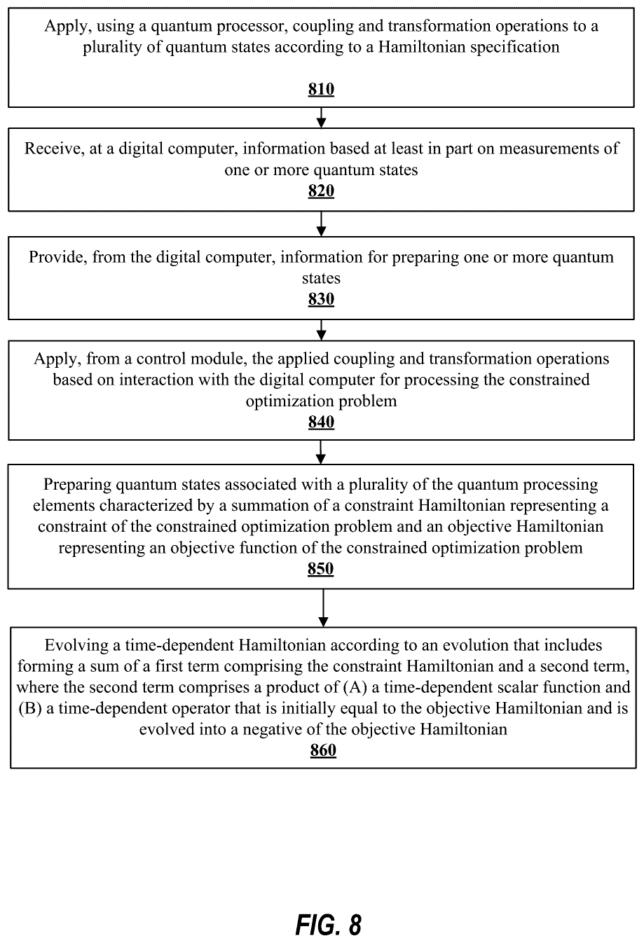

FIG. 8 is a flowchart of an example process for processing a constrained optimization problem 800. In some implementations, one or more process blocks of FIG. 8 may be performed by a quantum processor, a classical processor, or a control system.

At 810 a quantum processor applies coupling and transformation operations to a plurality of quantum states according to a Hamiltonian specification. The quantum processor may include a plurality of quantum processing elements associated with respective quantum states. At 820 a digital computer receives information based at least in part on measurements of one or more quantum states associated with respective quantum processing elements of the quantum processor. At 830, the digital computer provides information for preparing one or more quantum states associated with respective quantum processing elements of the quantum processor based at least in part on the information. At 830, a control module applies the applied coupling and transformation operations based on interaction with the digital computer for processing the constrained optimization problem. At 840, the processing includes preparing quantum states associated with a plurality of the quantum processing elements characterized by a summation of a constraint Hamiltonian representing a constraint of the constrained optimization problem and an objective Hamiltonian representing an objective function of the constrained optimization problem. At 850, the control module evolves a time-dependent Hamiltonian according to an evolution that includes forming a sum of a first term having the constraint Hamiltonian and a second term. The second term includes a product of (A) a time-dependent scalar function and (B) a time-dependent operator that is initially equal to the objective Hamiltonian and is evolved into a negative of the objective Hamiltonian.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

Although the foregoing examples have been described in some detail for purposes of clarity of understanding, the invention is not limited to the details provided. There are many alternative ways of implementing the invention. The disclosed examples are illustrative and not restrictive.

What is claimed:

1. An apparatus for processing a constrained optimization problem, the apparatus comprising:
a quantum processor comprising a plurality of quantum processing elements associated with respective quantum states, and configured to apply coupling and transformation operations to a plurality of the quantum states according to a Hamiltonian specification;
a digital computer comprising at least one central processing unit, the digital computer configured to:
receive information based at least in part on measurements of one or more quantum states associated with respective quantum processing elements of the quantum processor; and
provide information for preparing one or more quantum states associated with respective quantum processing elements of the quantum processor based at least in part on the received information; and
a control module configured to control the applied coupling and transformation operations based on interaction with the digital computer for processing the constrained optimization problem, the processing comprising:
preparing quantum states associated with a plurality of the quantum processing elements characterized by a summation of a constraint Hamiltonian representing a constraint of the constrained optimization problem and an objective Hamiltonian representing an objective function of the constrained optimization problem; and
operating the control module to evolve a time-dependent Hamiltonian according to an evolution that includes forming a sum of a first term comprising the constraint Hamiltonian and a second term, where the second term comprises a product of (A) a time-dependent scalar function and (B) a time-dependent operator that is initially equal to the objective Hamiltonian and is evolved into a negative of the objective Hamiltonian.

2. The apparatus of claim 1, wherein the objective Hamiltonian comprises an even term, wherein the time-dependent operator locally rotates the even term.

3. The apparatus of claim 1, wherein the objective Hamiltonian comprises a plurality of even terms, wherein for each of the plurality of even terms the time-dependent operator comprises a second sum of local rotations of components of the even term divided by a number of components.

4. The apparatus of claim 3, wherein the objective Hamiltonian comprises a plurality of odd terms, wherein for each of the plurality of odd terms the time-dependent operator comprises a sum of local rotations of components of the odd term divided by a number of components.

5. The apparatus of claim 3, wherein the objective Hamiltonian comprises a plurality of odd terms, further comprising:
partitioning the objective Hamiltonian into an odd objective Hamiltonian and an even objective Hamiltonian; and
globally rotating the odd objective Hamiltonian.

6. The apparatus of claim 1, wherein the objective Hamiltonian comprises a sum of weighted terms that represent the constrained optimization problem, and at least two of the weighted terms have different weights from each other.

7. The apparatus of claim 6, wherein the weighted terms correspond to respective vertices, edges, or hyperedges of a graph or hypergraph.

8. The apparatus of claim 1, wherein the constrained optimization problem comprises a weighted constrained optimization problem.

9. The apparatus of claim 8, wherein the weighted constrained optimization problem comprises a problem selected from the group consisting of: weighted maximum independent set, weighted maximal clique, weighted minimum vertex cover, weighted maximum set packing, weighted minimum dominating set, weighted minimum set cover, and weighted minimum dominating set on a directed graph.

10. The apparatus of claim 1, wherein the constrained optimization problem comprises an inequality constraint and wherein the objective Hamiltonian is modified by a slack variable mixing operator.

11. The apparatus of claim 10, the slack variable mixing operator is an identity plus a term that mixes slack variable amongst themselves.

12. The apparatus of claim 1, wherein the constrained optimization problem comprises a knapsack problem.

13. The apparatus of claim 1, wherein the constrained optimization problem comprises a combinatorial auction problem.

14. A method for processing a constrained optimization problem, the method comprising:
applying, using a quantum processor, coupling and transformation operations to a plurality of quantum states according to a Hamiltonian specification, wherein the quantum processor comprises a plurality of quantum processing elements associated with respective quantum states;
receiving, at a digital computer, information based at least in part on measurements of one or more quantum states associated with respective quantum processing elements of the quantum processor;
providing, from the digital computer, information for preparing one or more quantum states associated with respective quantum processing elements of the quantum processor based at least in part on the information; and
applying, from a control module, the applied coupling and transformation operations based on interaction with the digital computer for processing the constrained optimization problem, the processing comprising:
preparing quantum states associated with a plurality of the quantum processing elements characterized by a summation of a constraint Hamiltonian representing a constraint of the constrained optimization problem and an objective Hamiltonian representing an objective function of the constrained optimization problem; and
operating the control module to evolve a time-dependent Hamiltonian according to an evolution that includes forming a sum of a first term comprising the constraint Hamiltonian and a second term, where the second term comprises a product of (A) a time-dependent scalar function and (B) a time-dependent operator that is initially equal to the objective Hamiltonian and is evolved into a negative of the objective Hamiltonian.

15. The method of claim 14, wherein the objective Hamiltonian comprises an even term, wherein the time-dependent operator locally rotates the even term.

16. The method of claim 14, wherein the objective Hamiltonian comprises a plurality of even terms, and wherein for each of the plurality of even terms the time-dependent operator comprises a sum of local rotations of components of the even term divided by a number of components.

17. The method of claim 16, wherein the objective Hamiltonian comprises a plurality of odd terms, wherein for each of the plurality of odd terms the time-dependent operator comprises a second sum of local rotations of components of the odd term divided by a number of components.

18. The method of claim 16, wherein the objective Hamiltonian comprises a plurality of odd terms, further comprising:
partitioning the objective Hamiltonian into an odd objective Hamiltonian and an even objective Hamiltonian; and
globally rotating the odd objective Hamiltonian.

19. The method of claim 14, wherein the constrained optimization problem comprises an inequality constraint and wherein the objective Hamiltonian is modified by a slack variable mixing operator.

20. The method of claim 19, the slack variable mixing operator is an identity plus a term that mixes slack variable amongst themselves.
